(19) United States
(12) Patent Application Publication
(10) Pub. No.: US 2025/0084882 A1
(43) Pub. Date: Mar. 13, 2025

(54) RAIL SPLICE FOR MOUNTING SOLAR PANEL MODULES

(71) Applicant: Unirac, Inc., Albuquerque, NM (US)

(72) Inventor: Neha Avadhoot, Telangana (IN)

(21) Appl. No.: 18/826,992

(22) Filed: Sep. 6, 2024

Related U.S. Application Data
(60) Provisional application No. 63/537,418, filed on Sep. 8, 2023.

(51) Int. Cl. F16B 7/04; H02S 20/23

(52) U.S. Cl. CPC F16B 7/042; H02S 20/23

(57) ABSTRACT

A rail splice for a mounting system of a solar module that is used to connect the solar module to a surface is described. The rail splice fits in a first end of a first rail and a second end of a second rail to connect the first rail and the second rail together into a single rail having an extended length. The rail splice includes a stop at a middle position of the length of the rail splice to prevent over-insertion of the rail splice into either the first or second rail. The rail splice also includes tabs for providing an electrical connection between the rail splice, first rail, and second rail.

### RELATED APPLICATIONS

This application claims priority to U.S. Provisional Patent Application No. 63/537,418, filed on Sep. 8, 2023, the entire contents of which are incorporated herein by reference.

### BACKGROUND

As the solar energy industry continues to grow, the equipment to mount photovoltaic (PV) modules on different types of structures and/or locations continues to adapt and improve as well. Conventional PV module mounting assemblies are frequently designed with a specific use according to a particular surface structure. As such, conventional mounting assemblies frequently lack the ability to be implemented on multiple different structures, locations, and configurations. Despite the numerous existing systems for mounting solar panel modules, there is room for improvement.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items. Furthermore, the drawings may be considered as providing an approximate depiction of the relative sizes of the individual components within individual figures. However, the drawings are not to scale, and the relative sizes of the individual components, both within individual figures and between the different figures, may vary from what is depicted. In particular, some of the figures may depict components as a certain size or shape, while other figures may depict the same components on a larger scale or differently shaped for the sake of clarity.

FIGS. 1A and 1B illustrate a perspective view of a rail for an exemplary solar panel mounting system including a rail splice inserted therein to connect the rail to an adjacent rail, according to an embodiment of this disclosure.

FIG. 2 illustrates a perspective view of a rail splice, according to an embodiment of this disclosure.

FIG. 3 illustrates a detailed view of an electrical connection of the rail splice, according to an embodiment of this disclosure.

FIG. 4 illustrates a detailed view of a stop of the rail splice, according to an embodiment of this disclosure.

FIG. 5 illustrates a perspective view of a rail splice including a clip with a stop and electrical connection inserted into a rail of an exemplary solar panel mounting system, according to an embodiment of this disclosure.

FIG. 6 illustrates a perspective view of the rail splice of FIG. 5, according to an embodiment of this disclosure.

FIG. 7 illustrates a perspective view of a clip for fitting in the channel of the rail splice of FIG. 6, according to an embodiment of this disclosure.

FIG. 8 illustrates an end view of a compressible rail splice including a stop and electrical connection, according to an embodiment of this disclosure.

FIG. 9 illustrates a perspective view of the rail splice of FIG. 8, according to an embodiment of this disclosure.

FIG. 10 illustrates a perspective view of a rail splice with a stop and electrical connection on opposite sides of the rail splice, according to an embodiment of this disclosure.

FIG. 11 illustrates a second perspective view of the rail splice of FIG. 10, according to an embodiment of this disclosure.

### DETAILED DESCRIPTION

This description is directed to a mounting system of components for mounting a solar panel module to a roof or other surface. The system and/or one or more components thereof may alternatively be referred to as an apparatus. Features of the system are further described as shown in the figures and expressed in the claims listing.

The mounting system may mount solar panel modules to a roof or other surfaces, structures, machines, etc. For example, the mounting system may be used to mount modules to walls, to the ground, to poles, to bridges, to vehicles, etc. The sizes of the modules may vary. That is, the various distinct manufacturers of modules have not standardized the sizes of the modules available in the industry, and thus the size of each module may vary based on the manufacturer producing the module. For example, one manufacturer may produce a module having a thickness (e.g., height) of about 32 millimeters (mm), while another manufacturer may produce another different module having a thickness of about 40 mm. As such, the mounting system may include a clamp assembly that attaches to the rail segment and electrically bonds with any one of the modules having a different thickness. For example, the clamp assembly may attach to the rail segment and electrically bond to a module having a thickness of about 32 mm. In another example, the clamp assembly may attach to the rail segment and electrically bond to another different module having a thickness of about 40 mm. The mounting system as described herein facilitates a user (e.g., an installer, a technician, etc.) to quickly and easily install modules having varying thicknesses on surfaces such as the ground or a roof, structures, machines, etc. as desired. The clamp assembly may provide for fitting modules having a size of at least about 32 mm to about 40 mm. However, the range of thicknesses as aforementioned is not to be understood as a limit on the capability of the instant disclosure to accommodate sizes outside of that range.

In particular, when installing a solar racking system on a structure such as a roof, various components are used to accommodate the different unique situations, geometry, locations, and characteristics of the structure. Accordingly, the solar module mounting system includes rails for mounting to the structure that the solar modules are then connected to during installation. Accordingly, for an installation of a plurality of solar modules, it is desirable to have a continuous run of rails to install the solar modules. The rails may be produced in various lengths but may need to be spliced together to provide a custom length for a particular rail. A rail splice component, as described herein, provides for connecting two rail segments abutted together. The two rail segments are positioned end to end with the rail splice fitted between the ends of the rail segments. The rail splice enables the two rail segments to be connected end to end to form a rail having a length of at least the combined length of the two rail segments.

The rail segments may include extruded rail components having an external profile and an internal profile. The external profile and internal profile may correspond to the shape of the rail segment at a cross-section taken perpendicular to a length direction of the rail segment. The external profile may be configured to engage with clamps and/or mounting structures of the solar module mounting system and may include channels and shapes for such purposes on the outside perimeter of the rail segments. The internal profile defines a perimeter for an internal passage that extends a length of the rail segment and receives a rail splice to connect adjacent and abutting ends of rail segments.

Though particular embodiments are described herein with respect to extrusions and extruded components, other methods of manufacture and formation may be used. For instance, components referred to as extruded or including extruded parts may also be formed through bending sheet metal, three-dimensional printing, and other such manufacturing methods and techniques.

The rail splice includes a body having an elongated shape formed of a rigid material such as a composite, plastic, aluminum, steel, stainless steel, or other metal or rigid material. The body may include an extruded body shape having a profile that defines an outside perimeter of the rail splice. The profile, and therefore the outside perimeter is sized and shaped to fit within an opening or passage of the rail segment. The profile of the rail splice and the profile of the rail components may vary based on the particular implementations and design of the solar module mounting system.

As described herein, the rail splice may be assembled between two adjacent rail segments in a tool-less manner to save time for an installer. To promote the tool-less installation, the rail splice provides for a physical stop to prevent over-insertion of the rail splice into the ends of the rail segments. The physical stop ensures that the rail splice is insertable into the ends of the rail segments and will be capable of easily inserting into each rail segment without requiring tools or fasteners to secure the rail splice to one or both of the rail segments.

In an embodiment, the rail splice may be an aluminum extrusion with a first cross-section. The rail splice may be extruded and cut to particular lengths, such as a length in a range of four inches to twenty-four inches or more. In the wall of the extrusion, features are included to provide a physical stop as well as an electrical connector between the rail splice and the rail component. The physical stop may be formed by first cutting or forming an access in a first side of the extrusion and then inserting a tool to press or push out a portion of the wall of the extrusion. The physical stop extends outwards from the external perimeter of the extrusion. The material of the extrusion wall may be pushed out to form a protruding bulge. This bulge may be used to prevent the rail splice from completely entering into an internal passage of the rail component. With the physical stop positioned at a middle of the rail splice, the physical stop may also be used to center the rail splice at the splice connection between a first rail component and a second rail component. The rail splice component is a single part without fasteners making it easy to install without any need for tools. The physical stop may be fabricated from the single piece of the rail splice. One or more additional accesses may be cut into the wall of the extrusion. On an opposite side wall of the rail splice from the one or more additional accesses, semi-open shapes (e.g., a U-shape) may be cut through the wall. The semi-open shape may then be bent outwards by a tool inserted through the one or more additional accesses. The semi-open shape may have sharp edges that scratch the rail component (e.g., formed of aluminum) and break through a surface treatment (e.g., anodization and/or oxide layer) of the aluminum forming the rail component as the rail splice is inserted into the rail component. The bent tabs may then be used to form an electrical connection between the rail splice and the rail component. In an example, a semi-open shape may be positioned on either side of the physical stop to provide a continuous electrical connection between a first rail component, a rail splice, and a second rail component. The electrical connection may be used for grounding the mount system or for other electrical connections as required by the mount system.

In an embodiment, the rail splice may be an aluminum extrusion with a first cross-section. The rail splice may be extruded and cut to particular lengths, such as a length in a range of four inches to twenty-four inches or more. The profile of the extrusion defines a channel with an outermost edge of the channel having a distance across the channel less than a distance across the channel at or near a bottom of the channel. The rail splice with the channel may receive a clip. The clip may fit in the channel with an interference fit to prevent the slip from moving along the length of the channel. The clip may be inserted without the use of tools and the rail splice may therefore be toollessly assembled with the rail components. The clip may include tabs at edges of the clip as well as a center tab. The tabs at the edges of the clip may scratch at the inner surface of the rail component and may provide an electrical connection or electrical bond between the rail splice and the rail component. The center tab may act as a stop and prevent the rail splice from being completely inserted into the rail component (e.g., prevents inserting the entire length of the rail splice in a single rail component). The center tab may extend a greater distance from the surface of the rail splice extrusion and therefore prevent the over-insertion of the rail splice. The edge tabs of the clip may extend from the surface of the rail splice a distance that enables the edge tabs to fit within the interior of the rail component.

In another embodiment, the rail splice may be a metal extrusion with a cross-section defining the shape of the extrusion. The rail splice may be extruded and cut to particular lengths, such as a length in a range of four inches to twenty-four inches or more. In the wall of the extrusion, features are included to provide a physical stop as well as an electrical connector between the rail splice and the rail component. The physical stop may be formed by first cutting or forming an access in a first side of the extrusion. In a second side of the extrusion opposite from the access, one or more tabs may be cut into the wall of the extrusion. The one or more tabs may include a first tab and a second tab, with the first tab connected to the body of the extrusion and bent outwards to form the stop and the second tab connected to the body of the extrusion and bent outwards to form the stop. The first tab and the second tab may be curved from the connected ends into a curved or C-shape with a distal end of the tab directed towards a first or a second end of the rail splice, respectively. One or more additional accesses are cut into the wall of the extrusion. On an opposite side wall of the rail splice from the one or more additional accesses, semi-open shapes (e.g., a U-shape) may be cut through the wall. The semi-open shape may then be bent outwards by a tool inserted through the one or more additional accesses. The semi-open shape may have sharp edges that scratch the rail component (e.g., formed of aluminum) and break through a surface treatment (e.g., anodization and/or oxide layer) of the aluminum forming the rail component as the rail splice is inserted into the rail component. The bent tabs may then be used to form an electrical connection between the rail splice and the rail component. In an example, a semi-open shape may be positioned on either side of the stop to provide a continuous electrical connection between a first rail component, a rail splice, and a second rail component. The electrical connection may be used for grounding the mount system or for other electrical connections as required by the mount system.

In yet another embodiment, a method of forming a rail splice for connecting adjacent ends of rail components of a solar module mounting system may include forming an extruded body having an external profile configured to fit within an internal profile of the rail components. The method may also include forming a first opening in a first side wall of the extruded body. The method may also include forming a second opening in a second side wall of the extruded body. A stop may be formed by pressing a first tool through the first opening and deforming a portion of the extruded body away from a center of the extruded body. An electrical connection may be formed by cutting a u-shaped opening opposite the second opening and bending the electrical connection away from the center of the extruded body by inserting a second tool through the second opening.

In an embodiment, a rail system for mounting a solar panel module to a structure is described herein. The rail system may include a first rail component having a first extruded body with a first profile and extending along a first axis. The first rail component may also define a first interior passage having a first perimeter defined by a second profile. The system may also include a second rail component having a second extruded body with the first profile and extending along a second axis. The second rail component may also define a second interior passage having a second perimeter defined by the second profile. A rail splice formed of a third extruded body having a third profile defining an external perimeter may be configured to mate with the second profile. Additionally, the rail splice may include a stop positioned at a first position along a length of the rail splice, the stop protruding from the third profile and configured to prevent the rail splice from being inserted into the first rail component or the second rail component beyond the stop.

In an embodiment, the rail splice defines a channel along the length of the rail splice; and the stop may include an insert configured to slidably rest within the channel at a position along the length of the rail splice. The insert may include a clip body having a length and a width configured to fit within the channel. The clip body may include a first tab extending from the clip body a first distance and a second tab extending from the clip body a second distance less than the first distance. The first tab may act as a stop and the second tab may act as an electrical connector between the rail splice and the rail component. The rail splice may define an opening on a first side of the third extruded body with the stop positioned on a second side of the third extruded body, and the stop may include a protrusion pressed out from the wall of the rail splice or a deformed portion of the rail splice. The rail splice may further include an electrical connector positioned at a second position along the length of the rail splice. The electrical connector may include a tab extending from a surface of the rail splice and be configured to provide an electrical contact between the rail splice and one of the first rail component or the second rail component. The rail splice may define a first opening on a first side of the rail splice with the electrical connector positioned on a second side of the rail splice opposite the first opening. The electrical connector may include a pressed-out tab angled outwards from the surface of the rail splice. The rail splice may further define a second opening on the second side of the rail splice with the stop positioned on the first side of the rail splice. In an embodiment, the rail splice defines the second opening on the first side of the rail splice with the stop positioned on the second side of the rail splice. The tab of the electrical connector may extend a first distance from a surface of the rail splice and the stop extends a second distance from the surface of the rail splice. The second distance may be greater than the first distance. The external perimeter of the third profile of the rail splice may define a gap that enables the rail splice to be compressed in a direction substantially perpendicular to the length of the rail splice.

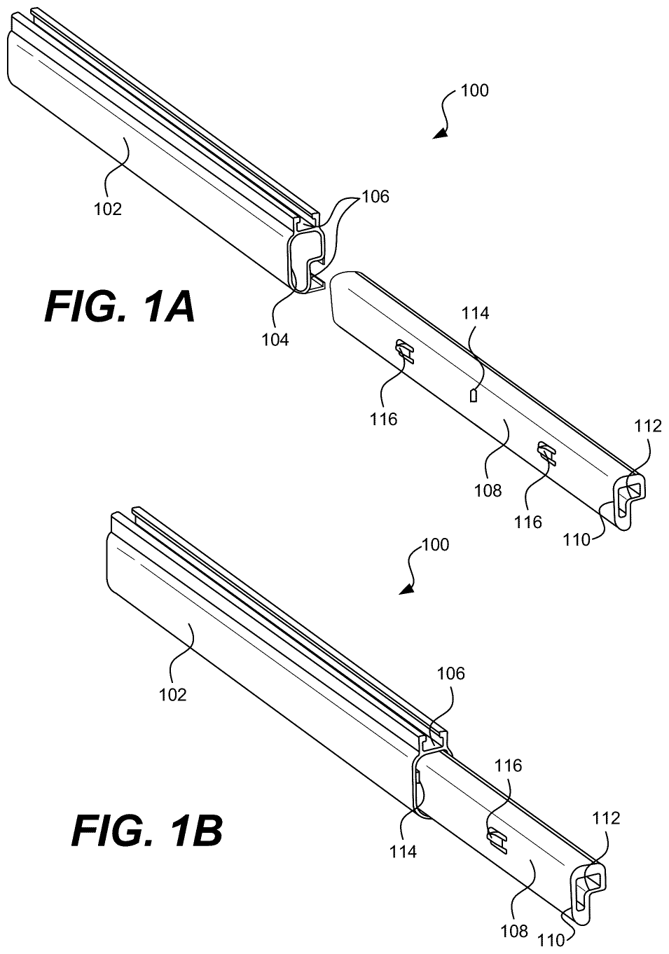

FIGS. 1A and 1B illustrate a perspective view of a rail system 100 for a solar panel mounting system including a rail 102 with a rail splice 108 inserted therein to connect the rail 102 to an adjacent rail, according to an embodiment. The rail 102, which may include an elongated member having a channel or passage therein that extends through all or a portion of the length of the rail 102. While FIG. 1A illustrates a rail system 100 including one rail 102, the mounting system 100 may include a plurality of rails 102. For example, a plurality of rails 102 may be disposed underneath rows of solar modules for the length of the array of solar modules. The rail 102 may be referred to as one of many contemplated possibilities of an “intermediary member” in that, in this instance, the expected use of the components of the mounting system 100 is to support solar panel modules upon a structure to prevent the modules from being directly against the mounting surface. Hence, the term “intermediary member” may be used whether a “rail” is used or if instead, a substitute structure becomes the structure between (i.e., intermediate to) the mounted object (e.g., the solar panel module or other desired apparatus, device, etc.) and the roof or surface. In other words, while in the solar panel industry, the mounting system 100 is used for mounting solar panel modules on a rail segment structure, it is contemplated that there may be additional uses for one or more of the components of the mounting system 100 or the system in its entirety. For example, minor adaptations may potentially be needed to serve other industries more effectively. Regardless of use, any use of the components as may be claimed based on the disclosure herein is considered proprietary to the applicant and within the scope of the disclosure.

Returning to the rail mounting system 100, the rail 102 may be attached to a bracket that is in turn attached to a roof. The rail 102 may be an extrusion. For example, the rail 102 may be a metal extrusion, such as an aluminum extrusion, although other suitable materials for manufacture may be considered according to desired performance and function. As used herein, the term “rail” may refer either to a full-length rail member according to various standards in the industry for rails, or to shorter segments less than a standard sized rail, such as those depicted in a figure in some instances. However, for the sake of this description, reference to a rail, rail component, or rail segment is to be understood to include a full-length rail or a shorter than full length portion of a rail, inasmuch as the term segment is relative to different manufacturing standards anyway.

The rail 102 defines an internal passage 104 that extends along the length of the rail 102. The internal passage 104 may have a profile that may vary according to one or more implementations. The internal passage 104 may receive a rail splice 108 for joining the rail 102 with a second rail positioned adjacent to the rail 102 with the ends of the rails abutted against one another. The rail 102 further includes a channel 106 that may be used for a clamp or other mounting structure to connect the rail 102 to one or more solar modules.

The rail splice 108 is depicted in FIG. 1A before being inserted into the rail 102 and is shown inserted into the rail 102. The rail splice 108 has an outer profile 110 that corresponds to the profile of the internal passage 104. The outer profile 110 may correspond to the profile of the internal passage 104 by enabling the rail splice 108 to be inserted into the internal passage 104. In an embodiment, the outer profile 110 may fit within the internal passage 104 as a clearance fit such as a sliding fit. In an embodiment, the fit may also include a transition fit up to an interference fit. A clearance fit or transition fit may enable an assembler/user to insert the rail splice 108 into the internal passage 104 without requiring a tool to press the rail splice 108 into the rail 102.

The rail splice 108 further includes an internal passage 112 that may have a profile that reduces the weight of the rail splice 108 and/or reduces a wall thickness of the rail splice 108 as compared with a solid extrusion shape.

The rail splice 108 includes a stop 114 that is positioned on a first side of the rail splice 108 and is configured to stop insertion of the rail splice 108 at a predetermined position or length within the rail 102. Accordingly, the rail splice 108 is received by the rail 102 to the stop 114. The stop 114 provides a physical barrier to prevent insertion of the rail splice beyond the stop as the stop interferes with the wall of the rail 102 once the stop 114 reaches the end of the rail 102. With the stop 114 positioned at a middle of the rail splice 108, the stop 114 may also be used to center the rail splice 108 at the splice connection between a rail 102 and a second rail. As depicted in FIG. 1B, the stop 114 bottoms out at the edge of the rail 102 leaving a portion of the rail splice 108 to be inserted into a second rail to extend a length of a rail component. Accordingly, FIG. 1B illustrates a top perspective view of a rail mounting system 100 with the rail splice 108 at least partially received by the rail 102. The rail splice 108 is configured to extend a running length of a line of consecutive rails by connecting, for example, the rail 102 to a second rail segment (not shown in FIG. 1B). Accordingly, the rail splice 108 may be used for connecting two rails while maintaining the strength of a continuous rail.

In an embodiment, the rail splice 108 may include tabs 116 to provide an electrical connection between the rail 102 and the rail splice 108. The tabs 116 may be formed by cutting a semi-open shape (e.g., a U-shape) is cut through the wall of the rail splice 108. The semi-open shape is bent outwards to form the tab 116. The tab 116 has sharp edges that scratch a surface of the rail 102 (e.g., formed of aluminum) and breaks through a surface treatment (e.g., anodization and/or oxide layer) of the aluminum forming the rail 102 as the rail splice 108 is inserted into the rail 102. The tab 116 provides an electrical connection between the rail splice 108 and the rail 102. As depicted in FIG. 1A, a tab 116 is positioned on either side of the stop 114 (e.g., a tab 116 positioned on a first side of the stop 114 and a tab 116 positioned on a second side of the stop 114).

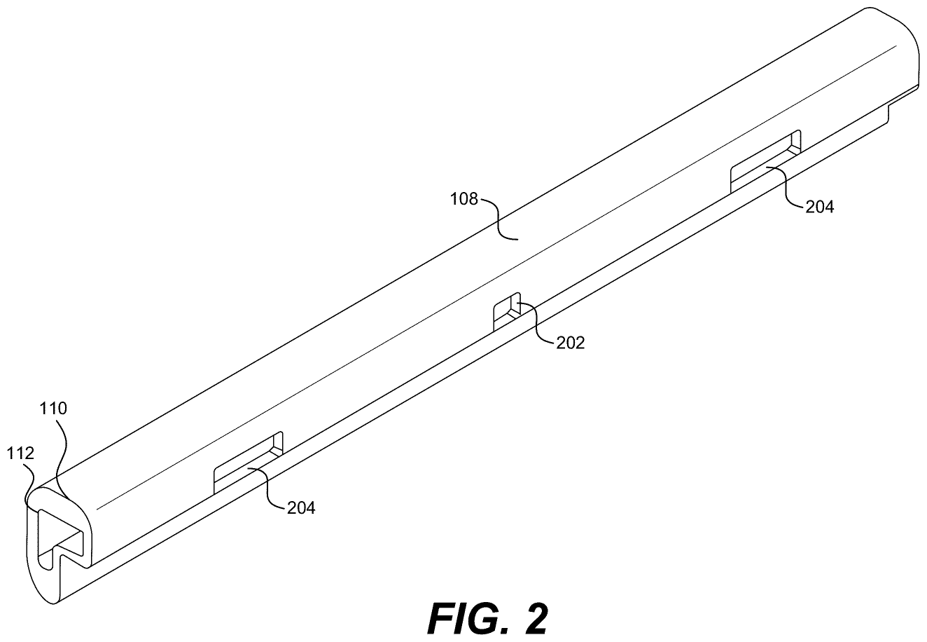

FIG. 2 illustrates a perspective view of the rail splice 108 of FIG. 1, according to an embodiment. The rail splice 108 is depicted showing a second side of the extrusion not visible in FIGS. 1A-1B. The rail splice 108 defines a first access 202 and a second access 204. The second access 204 may be positioned on the second side of the extrusion directly opposite from the stop 114. For example, the second access 204 may be positioned on the second side of the extrusion directly opposite from the tab 116. The rail splice 108 includes two tabs and therefore also includes two second accesses 204, with one second access for each of the tabs 116.

In an embodiment, the stop 114 may be formed by passing a tool through the first access 202 to press or push out a portion of the wall of the extrusion. The stop 114 extends outwards from the external perimeter of the extrusion. The material of the extrusion wall is pushed out to form a protruding bulge. This bulge is used to prevent the rail splice 108 from completely entering into an internal passage of the rail component. In an example, the tool may be pressed against the internal wall of the rail splice 108 by passing through the first access 202. At the same time, a second tool such as a die, may be pressed against the outside of the first side of the rail splice 108 such that the tool pushing through the first access 202 forms a stop 114 having a particular shape as defined by the tool and die.

The second accesses 204 may be cut into the wall of the rail splice 108 to bend the tabs 116 outwards to form the electrical connections described herein. The tabs 116 are cut into the first side of the rail splice 108. On the second side, opposite from the first side, the second accesses 204 are provided. The tabs 116 are formed by first cutting semi-open shapes (e.g., a U-shape) through the wall of the first side. The semi-open shape is then bent outwards by a tool inserted through the second access 204. Though described with respect to FIGS. 1A, 1B, and 2, with the stop 114 and the tabs 116 on the same side of the rail splice 108, in an embodiment, the stop 114 may be on an opposite side from the tabs 116. In such examples, the first access 202 may be on the opposite side from the second accesses 204.

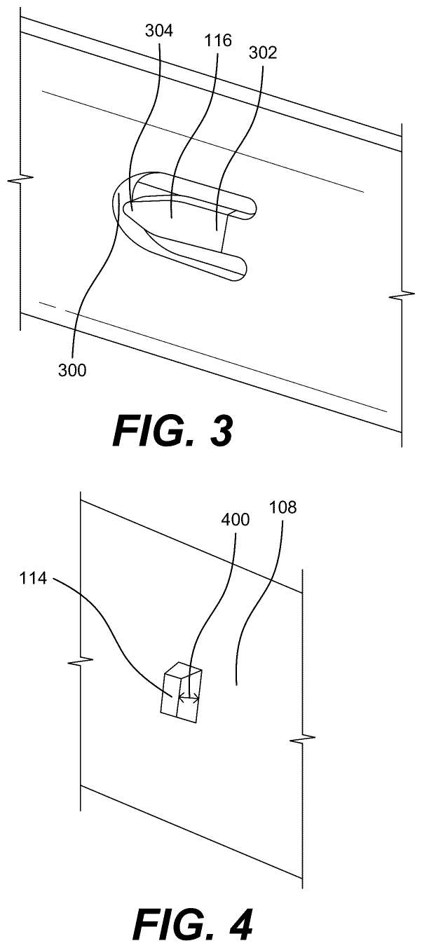

FIG. 3 illustrates a detailed view of a tab 116 for an electrical connection of the rail splice 108, according to an embodiment. The tab 116 is formed in the rail splice 108 by cutting a semi-open shape 300 thus forming the tab 116. The tab 116 includes a proximal end 302 connected to the remainder of the extruded body while a distal end 304 of the tab 116 is free to be displaced by a tool to form a bent tab. The semi-open shape 300 is shown in FIG. 3 as being formed by a U-shaped cut, but in an embodiment, the semi-open shape 300 may have other shapes or configurations. The semi-open shape 300 may be formed of a cut that cuts substantially around a perimeter of a shape but leaves a connected end of the tab 116 secured to the wall of the rail splice 108. The semi-open shape 300 may be formed by cutting through the wall of the extrusion body forming the rail splice 108. The semi-open shape 300 may be formed by cutting along an open shape path. An open shape includes any shape in which the start point and the end point are different and not connected. Open shapes are not continuous and therefore result in creation of the tab 116 when an open shape profile is cut in the rail splice 108.

The tab 116 is cut by cutting the semi-open shape 300 and then bending the resulting shape of the tab 116 outwards from the surface of the rail splice 108. The semi-open shape 300 is cut and the tab 116 is then bent outwards by a tool inserted through the second access 204. The tab 116 may have sharp edges as a result of the cutting of the semi-open shape 300 that scratch the rail 102 (e.g., formed of aluminum) and breaks through a surface treatment (e.g., anodization and/or oxide layer) of the aluminum forming the rail 102 as the rail splice 108 is inserted into the rail 102. The tab 116 may then be used to form an electrical connection between the rail splice 108 and the rail 102. The electrical connection may be used for grounding the mount system or for other electrical connections as required by the mount system.

FIG. 4 illustrates a detailed view of a stop 114 of the rail splice 108, according to an embodiment. The stop 114 may be formed by passing a tool through the first access 202 to press or push out a portion of the wall of the extrusion. The stop 114 extends outwards from the external perimeter of the extrusion. The stop 114 is depicted with a truncated rectangular pyramid shape, though other shapes and configurations are contemplated including a frusto-conical shape or other such shapes that may be formed by pressing a tool and/or a die. The stop 114 is used to prevent the rail splice 108 from completely entering into an internal passage of the rail 102. In an example, a tool may be pressed against the internal wall of the rail splice 108 by passing through the first access 202. At the same time, a second tool such as a die, may be pressed against the outside of the first side of the rail splice 108 such that the tool pushing through the first access 202 forms the stop 114 having a particular shape as defined by the tool and die.

The stop 114 has a height 400 that may correspond with a thickness of the wall of the extrusion of the rail 102. The height 400 may be in a range of five millimeters to ten millimeters. Accordingly, the height 400 prevents the rail splice 108 from fitting into the internal passage 112 of the rail 102.

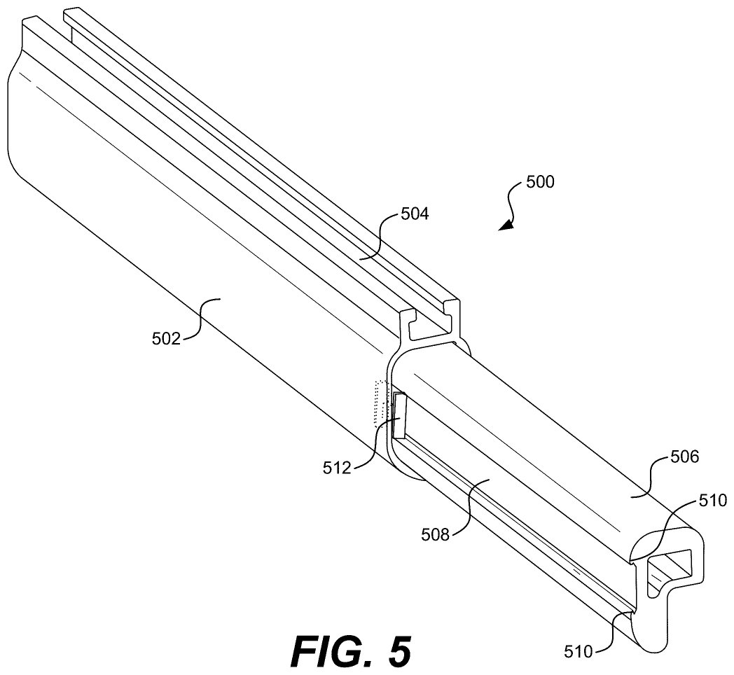

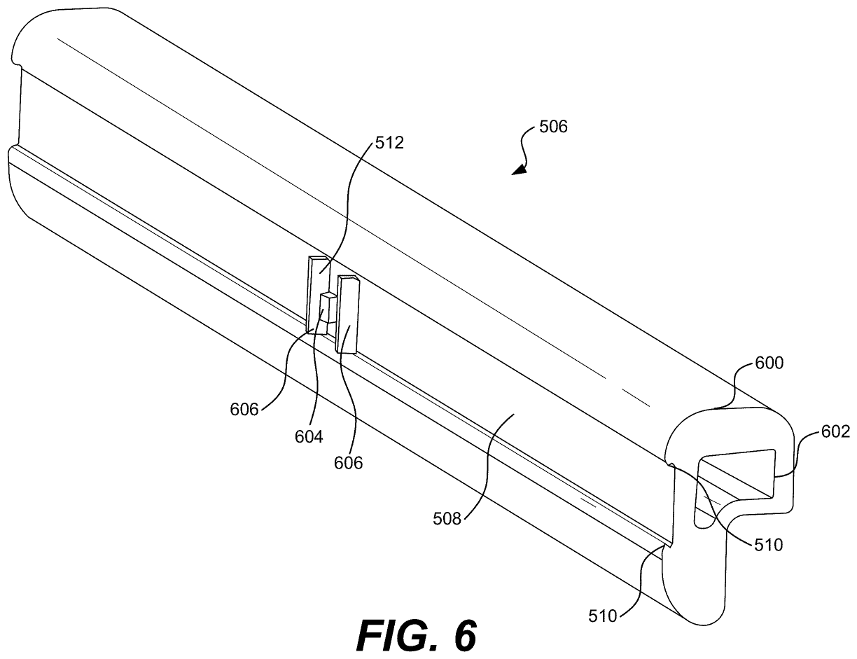

FIG. 5 illustrates a perspective view of rail system 500 including a rail 502 with a rail splice 506 including a clip 512 with a stop and electrical connection inserted into a rail of an exemplary solar panel mounting system, according to an embodiment. FIG. 6 illustrates a perspective view of the rail splice of FIG. 5, according to an embodiment. The rail 502 may be an example of the rail 102 and includes a channel 504 for connecting one or more clamping systems or structures for mounting the solar modules. The rail 502 is depicted as an extrusion with a first cross-section.

In an embodiment, the rail splice 506 may be extruded and cut to particular lengths, such as a length in a range of four inches to twenty-four inches or more. The profile of the extrusion of the rail splice 506 defines a channel 508. The channel 508 includes edges 510 that define the edges of the channel 508. The edges 510 are shown with an outermost edge of the channel (e.g., at or adjacent a top of the channel 508) having a distance across the channel 508 less than a distance across the channel at or near a bottom of the channel 508. The edges 510 result in the channel 508 providing a recess to slidably capture the clip 512 and resist or prevent removal of the clip 512 from the channel 508 in a direction substantially perpendicular to a length of the rail splice 506. The rail splice 506 includes an extruded body 600 defining an internal passage 602 that extends a length of the rail splice 506 and may reduce a weight of the rail splice 506.

The rail splice 506 with the channel 508 may receive a clip 512. The clip 512 fits in the channel 508 with an interference fit to resist movement of the clip 512 along the length of the channel 508. The clip 512 may be inserted without the use of tools and the rail splice 506 may therefore be toollessly assembled with the rail 502.

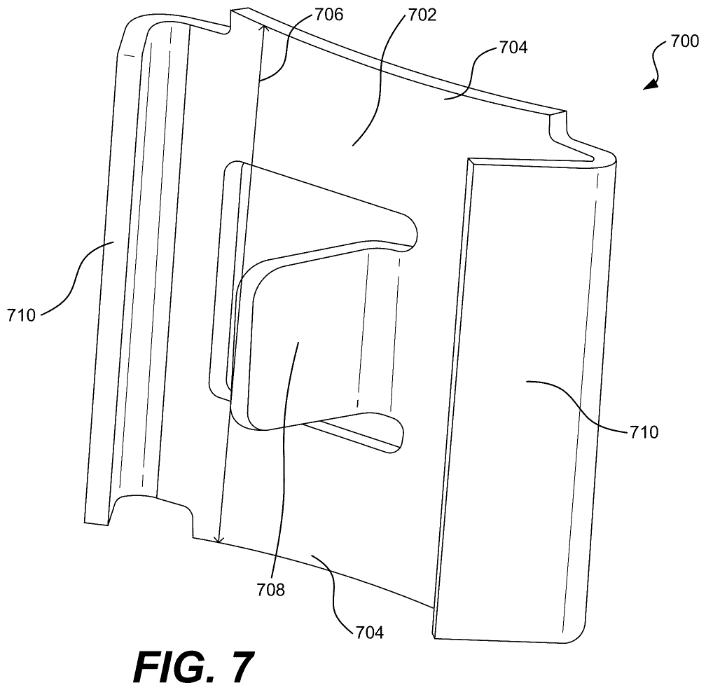

The clip 512 may include a stop 604 and tabs 606. The clip 512 is further shown and described with respect to FIG. 7, which shows a perspective view of a clip 700 for fitting in the channel 508 of the rail splice 506 of FIG. 6, according to an embodiment.

The clip 700 includes a body 702, first tabs 704, second tab 708, and third tabs 710. The first tabs 704 include edges of the body 702 that interface with the channel 508 and are captured by the edges 510 when the clip 700 is installed in the channel 508. The first tabs 704 are spaced apart by a distance 706 that corresponds to a width of the channel 508. In particular, the distance 706 is greater than a distance between edges 510 but fits within the channel 508.

The second tab 708 acts as a stop, similar to stop 114 or other stops as described herein. Accordingly, the second tab 708 has a first height that extends away from the body 702. The first height may be a height that interferes with the rail 102 to prevent the rail splice 108 from being over-inserted into the rail 102. The second tab 708 may act as a stop and may prevent the rail splice 108 from being completely inserted into the rail 102 (i.e., prevent inserting the entire length of the rail splice in a single rail component). The second tab 708 may extend a greater distance from the surface of the body 702 than the third tabs 710 and therefore may prevent the over-insertion of the rail splice.

In an embodiment, the third tabs 710 at the edges of the body 702 may scratch at the inner surface of the rail 102 and provide an electrical connection or electrical bond between the rail splice 108 and the rail 102. The third tabs 710 may extend from the surface of the rail splice 108 a distance that enables the edge tabs to fit within the interior of the rail 102. In an embodiment, the first tabs 704 may scratch an inner surface of the channel 508 and therefore connect the rail splice 506 to the rail 502 through the clip 512.

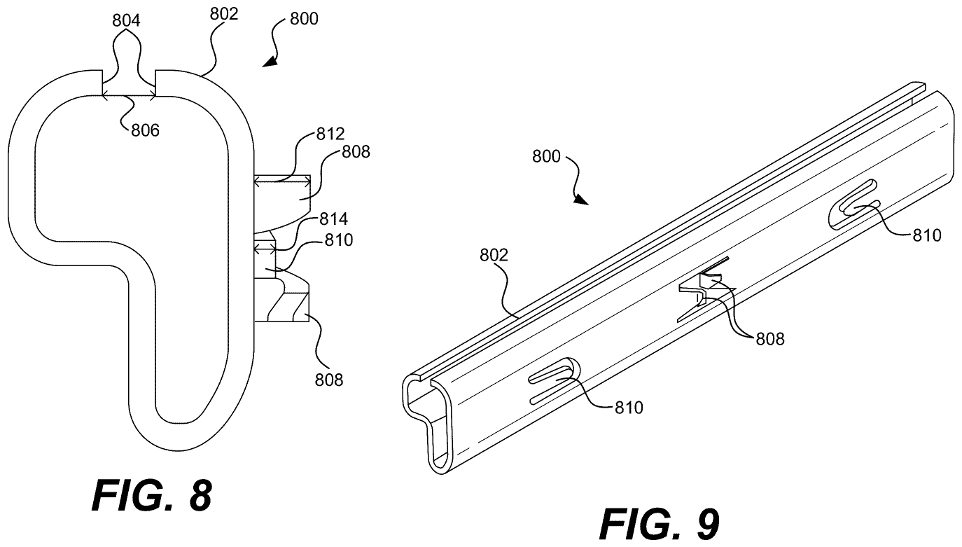

FIGS. 8-9 illustrate a rail splice 800 having a gap between ends 804 of a perimeter of a profile thereof, according to an embodiment. FIG. 8 illustrates an end view of a compressible rail splice including a stop and electrical connection, according to an embodiment. FIG. 9 illustrates a perspective view of the rail splice 800 of FIG. 8, according to an embodiment. The rail splice 800 includes an extruded body 802 similar or identical to the extruded body described herein. The rail splice 800 may be formed of metal or another similar material.

In an embodiment, the rail splice 800 may be extruded and cut to particular lengths, such as a length in a range of four inches to twenty-four inches or more. The extruded body 802 is an extruded profile that defines a gap between ends 804 of the perimeter of the extruded profile. The gap is defined by a distance 806 between the ends 804. The gap may be in a range of one to ten millimeters in an example. The gap may provide for the rail splice 800 to compress laterally, for example to aid insertion of the rail splice 800 into the rail 102.

The extruded body 802 includes features to provide a stop 808 as well as tabs 810 for an electrical connection between the rail splice 800 and a rail 102. The stop 808 shaped as two C-shaped tabs in an example, facing opposite ends of the rail splice 800. The stop 808 can therefore capture an end of each rail 102 within the C-shaped tabs when the rail splice 800 is inserted into end of rails 102.

The stop 808 may be formed by first cutting or forming an access in a first side of the extruded body 802. In a second side of the extruded body 802 opposite from the access, the C-shaped tabs may be cut into the wall of the extruded body. The one or more tabs may include a first tab and a second tab, with the first tab connected to the body of the extrusion and bent outwards to form the stop and the second tab connected to the body of the extrusion and bent outwards to form the stop 808. The first tab and the second tab may be curved from the connected ends into a curved or C-shape with a distal end of the tab directed towards a first or a second end of the rail splice 800, respectively.

As shown in the figures, in an embodiment, one or more additional accesses may be cut into the wall of the extruded body 802. On an opposite side wall of the rail splice 800 from the one or more additional accesses, the tabs 810 may be formed in the wall of the extruded body 802. As described herein, the tabs 810 may be cut in a semi-open shape that is then bent outwards by a tool inserted through the one or more additional accesses. The semi-open shape may have sharp edges that scratch the rail component (e.g., formed of aluminum) and breaks through a surface treatment (e.g., anodization and/or oxide layer) of the aluminum forming the rail 102 as the rail splice 800 is inserted into the rail component. The tabs 810 may then be used to form an electrical connection between the rail splice 800 and the rail 102.

As depicted in FIG. 8, the height 812 of the stop 808 is greater than a height 814 of the tabs 810. This height difference results in the tabs 810 fitting within the internal passage of a rail 102, while the stop 808 does not fit within the internal passage of the rail 102 due to the height difference.

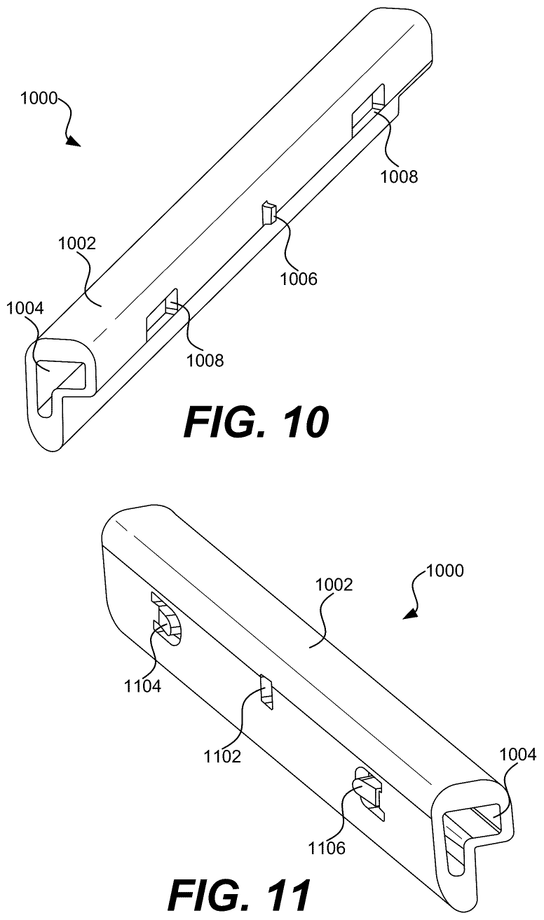

FIGS. 10 and 11 illustrate a rail splice having a stop and tabs as described herein, according to an embodiment. FIG. 10 illustrates a perspective view of a rail splice 1000 with a stop 1006 and accesses 1008 through the extruded wall of the rail splice 1000, according to an embodiment. FIG. 11 illustrates a second perspective view of the rail splice 1000 of FIG. 10, according to an embodiment. The rail splice 1000 may include an extruded body 1002, similar or identical to the extruded body of other rail splices described herein. The extruded body 1002 defines an internal passage 1004. As shown, in an embodiment, the extruded body 1002 may have accesses 1008 formed therein for interacting with tabs 1104 and 1106, and access 1102 may be formed therein for interacting with stop 1006.

The tabs 1104 and 1106 may be positioned on a first side of the extruded body 1002 with access 1102 also formed on the first side of the extruded body 1002. The stop 1006 and accesses 1008 are formed on a second side of the extruded body 1002. In an embodiment, the access 1102 is positioned on an opposite side from the stop 1006 such that the stop 1006 may be formed by a tool inserted through the access 1102. The accesses 1008 are positioned on a side of the extruded body 1002 opposite from the tabs 1104 and 1106. In some examples, the access 1102 and/or stop 1006 may be positioned on a side other than a side defining or including accesses 1008 or tabs 1104 and 1106.

Although several embodiments have been described in language specific to structural features and/or methodological acts, it is to be understood that the claims are not necessarily limited to the specific features or acts described. Rather, the specific features and acts are disclosed as illustrative forms of implementing the claimed subject matter.

What is claimed is:

1. A rail system for mounting a solar panel module to a structure, the rail system comprising:
a first rail component including a first extruded body having a first profile and extending along a first axis, the first rail component defining a first interior passage having a first perimeter defined by a second profile;
a second rail component including a second extruded body having the first profile and extending along a second axis, the second rail component defining a second interior passage having a second perimeter defined by the second profile; and
a rail splice including:
a third extruded body having a third profile defining an external perimeter configured to mate with the second profile; and
a stop positioned at a first position along a length of the rail splice, the stop protruding from the third profile and configured to prevent the rail splice from being inserted into the first rail component or the second rail component beyond the stop.

2. The rail system of claim 1, wherein:
the rail splice defines a channel along the length of the rail splice; and
the stop includes an insert configured to slidably rest within the channel at a position along the length of the rail splice.

3. The rail system of claim 2, wherein:
the insert includes a clip body having a length and a width configured to fit within the channel; and
the clip body includes:
a first tab extending from the clip body a first distance; and
a second tab extending from the clip body a second distance less than the first distance.

4. The rail system of claim 1, wherein:
the rail splice defines an opening on a first side of the third extruded body; and
the stop is positioned on a second side of the third extruded body and includes a pressed out portion of the rail splice.

5. The rail system of claim 1, wherein the rail splice further includes an electrical connector positioned at a second position along the length of the rail splice, the electrical connector including a tab extending from a surface of the rail splice and configured to provide an electrical contact between the rail splice and one of the first rail component or the second rail component.

6. The rail system of claim 1, wherein tab extends a first distance from a surface of the rail splice and the stop extends a second distance from the surface of the rail splice, the second distance greater than the first distance.

7. The rail system of claim 5, wherein:
the rail splice defines a first opening on a first side of the rail splice; and
the electrical connector is positioned on a second side of the rail splice opposite the first opening and includes a pressed out tab angled outwards from the surface of the rail splice.

8. The rail system of claim 7, wherein:
the rail splice defines a second opening on the second side of the rail splice; and
the stop is positioned on the first side of the rail splice.

9. The rail system of claim 7, wherein:
the rail splice defines a second opening on the first side of the rail splice; and
the stop is positioned on the second side of the rail splice.

10. The rail system of claim 1, wherein the external perimeter of the third profile of the rail splice defines a gap that enables the rail splice to be compressed in a direction substantially perpendicular to the length of the rail splice.

11. A rail splice comprising:
an extruded body having an external profile of a cross-section defining a vertical portion and a horizontal portion, the vertical portion extending from an end of the horizontal portion to form an L-shaped profile;
a stop positioned at a first position along a length of the extruded body including a protrusion extending from a surface of the extruded body; and
an electrical connection positioned at a second position along a length of the extruded body and configured to provide electrical continuity between the rail splice and one or more rail components.

12. The rail splice of claim 11, wherein the external profile defines a channel extending along the length of the extruded body, the channel having:
a first width at a first portion of the channel adjacent a bottom of the channel; and
a second width at a second portion of the channel, the second width less than the first width.

13. The rail splice of claim 12, wherein the stop includes an insert configured to slidably fit within the channel at a position along the length of the extruded body.

14. The rail splice of claim 13, wherein:
the insert includes a clip body having a length and a width; and
the clip body includes:
a first tab extending from the clip body a first distance; and
a second tab extending from the clip body a second distance less than the first distance.

15. The rail splice of claim 11, wherein:
the rail splice defines an opening on a first side of the extruded body; and
the stop is positioned on a second side of the extruded body and includes a pressed-out portion of the rail splice.

16. The rail splice of claim 11, wherein the electrical connection includes a tab extending from the extruded body, the tab connected to the extruded body at a proximal end and extending from the surface of the extruded body at a distal end.

17. The rail splice of claim 11, wherein tab extends a first distance from the surface of the rail splice and the stop extends a second distance from the surface of the rail splice, the second distance greater than the first distance.

18. The rail splice of claim 11, wherein the external profile of the cross-section further defines a gap that enables the extruded body to be compressed in a direction substantially perpendicular to the length of the rail splice.

19. A method of forming a rail splice for connecting adjacent ends of rail components of a solar module mounting system, the method comprising:
forming an extruded body having an external profile configured to fit within an internal profile of the rail components;
forming a first opening in a first side wall of the extruded body;
forming a second opening in a second side wall of the extruded body;
forming a stop by pressing a first tool through the first opening and deforming a portion of the extruded body away from a center of the extruded body;
forming an electrical connection by cutting a U-shaped opening opposite the second opening; and
bending the electrical connection away from the center of the extruded body by inserting a second tool through the second opening.

20. The method of claim 19, wherein the first side wall and the second side wall are position on opposite sides of the extruded body.
